(19) United States
(12) Patent Application Publication
(10) Pub. No.: US 2008/0149136 A1
(43) Pub. Date: Jun. 26, 2008

(54) METHOD OF CLEANING SEMICONDUCTOR DEVICE

(76) Inventor: Joon-Ku Yoon, Seoul (KR)

Correspondence Address: SHERR & NOURSE, PLLC, 620 HERNDON PARKWAY, SUITE 200, HERNDON, VA, 20170, US

(21) Appl. No.: 11/959,281

(22) Filed: Dec. 18, 2007

(30) Foreign Application Priority Data
Dec. 20, 2006 (KR) 10-2006-0130567

(51) Int. Cl. B08B 7/04; B08B 3/02; B08B 5/02; B08B 3/08

(52) U.S. Cl. 134/6; 134/21; 134/20; 134/61; 134/63

(57) ABSTRACT

A method of cleaning a semiconductor device. The method includes: A chemical cleaning using an organic solvent without using deionized water. An iso propyl alcohol cleaning using the iso propyl alcohol. Drying by inserting the semiconductor device into a dryer and then ejecting an inert gas thereto to dry and clean simultaneously. A method may clean a semiconductor device without using deionized water, so that corrosion of the semiconductor device can be substantially prevented by avoiding the use of deionized water, while substantially removing containments from the semiconductor device.

The present application claims priority under 35 U.S.C. 119 to Korean Patent Application No. 10-2006-0130567 (filed on Dec. 22, 2006), which is hereby incorporated by reference in its entirety.

### BACKGROUND

As information media technology (e.g. computers) has developed, semiconductor device fabrication technology has also developed. Development efforts in semiconductor device fabrication technology have included areas such as improved integration, fineness, operation speed, and/or other similar aspects. As circuit integration of some types of semiconductor devices has increased, there is a need for processing fine patterns in structures that include multiple kinds of semiconductor thin films in a multi-layer stack.

During processing of relatively highly integrated semiconductor devices, the number of fabrication processes is can be relatively high. From a relatively large number of fabrication processes, many residues and/or contaminants may remain on fabricated surfaces. Residues and/or contaminants may distort the structural shape of a semiconductor device and thus deteriorate the electrical characteristics of the semiconductor device. Deterioration of the electrical characteristics of a semiconductor device may have an adverse effect on the reliability and the yield of the semiconductor device. Accordingly, a cleaning process may be performed to remove residues and/or contaminants after certain semiconductor fabrication processes, which may prevent and/or minimize defects generated in subsequent semiconductor processes.

For example, when a cleaning process is performed after a pad open reactive ion etching (RIE) process or a backgrind process, there may be risk of corrosion of the semiconductor device from a cleaning liquid (or other materials). Accordingly, it may be desirable to have a cleaning method capable of completely or substantially removing residues after a fabrication process, while minimizing corrosion.

A method of cleaning a semiconductor device may include the following steps: Chemical cleaning a semiconductor device using an organic solvent. Iso propyl alcohol cleaning to remove cleaning liquid (and/or other agents) remaining on the semiconductor device using iso propyl alcohol (IPA). Deionized water cleaning the semiconductor device using deionized water (DIW). A final rinse (FR) and drying the semiconductor device.

A quick drain rinse (QDR) bath may be used in order to raise cleaning efficiency. A semiconductor device may be moved into a QDR bath filled with deionized water for cleaning for a predetermined period of time. If the deionized water and iso propyl alcohol are externally discharged after ios propyl alcohol is added to the QDR bath, the mixture of the deionized water and the iso propyl alcohol may be externally discharged according to the Malangony effect due to a cohesive power difference between the deionized water and the iso propyl alcohol. Accordingly, moisture may remain on the surface of the semiconductor device after it is removed. At the same time, water molecules and iso propyl alcohol liquid that are not treated on the semiconductor device may be discharged by ejecting N2 gas into the QDR bath, drying the semiconductor device.

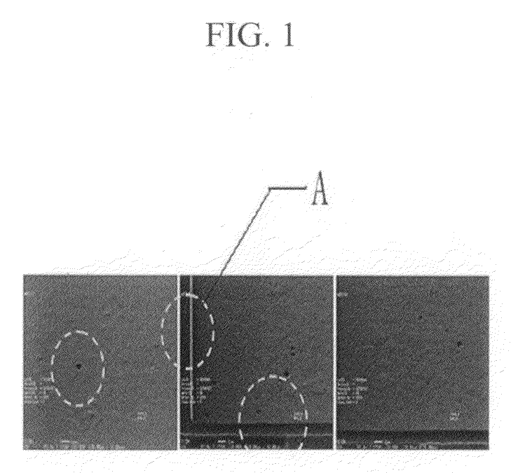

Example FIG. 1 is a view illustrating a state where corrosion is generated after the cleaning process due to a method of cleaning a semiconductor device. After passing through a cleaning process, corrosion A or a reactive source caused by corrosion A may be formed on the surface of the semiconductor device. Corrosion may occur on the surface of the semiconductor device due to a drying process of deionized water, if the deionized water is not substantially or completely removed, thus potentially reacting with the semiconductor device.

Complications may arise due to corrosion A or a reactive source caused by corrosion A being generated on the surface of the semiconductor device that is not observed or detected after the cleaning process. This unobserved or undetected corrosion may cause a cause of defect in a subsequent process (e.g. an adhesion process), which may reduce yield in a fabrication process of the semiconductor device.

### SUMMARY

Embodiments relate to a semiconductor device and/or a method of cleaning a semiconductor device. Embodiments provide a method of cleaning a semiconductor device without using deionized water, which may substantially prevent corrosion generated due to a cleaning of a semiconductor device, thus preventing formation of defects.

Embodiments relate to a method of cleaning a semiconductor device that prevents, substantially prevents, and/or minimizes the generation of corrosion on the surface of the semiconductor device without using deionized water for cleaning the semiconductor device and removing contaminants the semiconductor device that may be generated during fabrication of the semiconductor device.

Embodiments relate to a method of cleaning a semiconductor device comprising at least one of: Chemical cleaning a semiconductor device using an organic solvent without using deionized water. Iso propyl alcohol cleaning the semiconductor device using iso propyl alcohol. Drying by inserting the semiconductor device into a dryer and then ejecting an inert gas to dry simultaneously with cleaning.

### DRAWINGS

Example FIG. 1 is a view illustrating corrosion generated after a cleaning process.

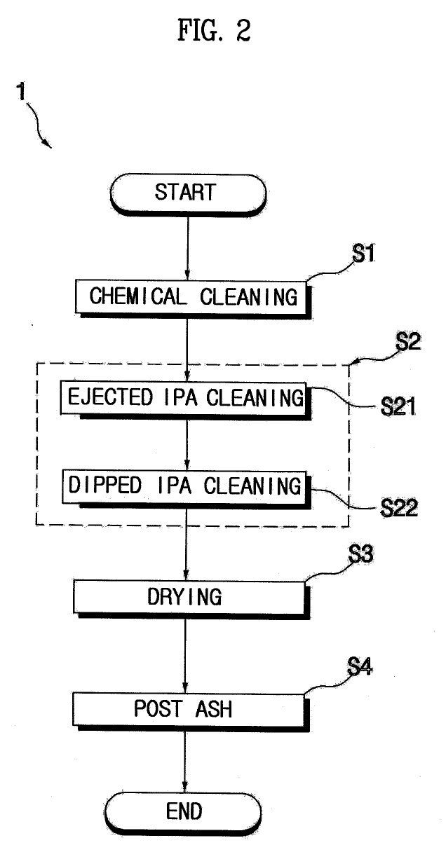

Example FIG. 2 is a flow chart illustrating a method of cleaning a semiconductor device, according to embodiments.

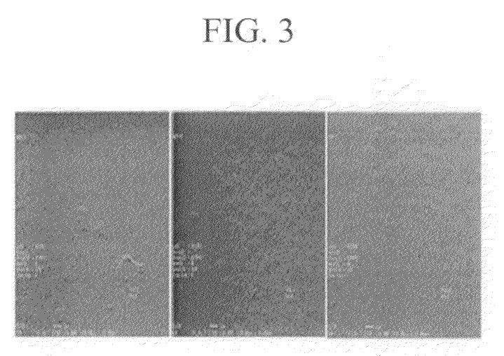

Example FIG. 3 is a view illustrating the state of a semiconductor device after a cleaning process, in accordance with embodiments.

### DESCRIPTION

Example FIG. 2 is a flow chart 1 illustrating a method of cleaning a semiconductor device, according to embodiments. A method of cleaning a semiconductor device may clean a semiconductor device without using deionized water so that it can maintain cleaning effects, while preventing the corrosion on the surface of the semiconductor device after the cleaning process, in accordance with embodiments. In embodiments, a method of cleaning a semiconductor device includes a chemical cleaning step (S1), an iso propyl alcohol cleaning step (S2), a drying step (S3), and a post ash step (S4).

Chemical cleaning step (S1) may be performed to remove residues attached to a semiconductor device after a fabricating process is performed. For example, a pad open reactive ion etching (RIE) process or a backgrind process may be performed, in accordance with embodiments. In embodiments, a semiconductor device may be cleaned using an organic solvent. For example, an organic solvent may use a solution of dimethylacetamide and diethanol amine (ACT-CMI).

In embodiments, in an iso propyl alcohol cleaning step (S2), a semiconductor device may be subject to chemical cleaning step (S1), which cleans the semiconductor device using iso propyl alcohol (IPA). An iso propyl alcohol cleaning step may include an ejected cleaning step (S21) and a dipped cleaning step (S22), in accordance with embodiments.

In an ejected cleaning step (S21), in order to clean the chemical residues from the organic solvent cured and absorbed due to temperature changes, iso propyl alcohol may be ejected into the semiconductor device being subject to the chemical cleaning step (S1), in accordance with embodiments. In other words, residues that are not removed in the chemical cleaning step (S1), as well as the cured chemical residues, may be physically removed by ejecting iso propyl alcohol to the semiconductor device through an ejecting nozzle at a predetermined pressure. In embodiments, iso propyl alcohol may be maintained at a normal temperature, so that the iso propyl alcohol is ejected safely.

In an ejected cleaning step (21), a semiconductor device may be dipped and cleaned in iso propyl alcohol (e.g. at normal temperature) that is contained in a predetermined bath. For example, fine particles (e.g. cured chemical residues or the residues not removed in the chemical cleaning step (S1) and the ejected cleaning step (S21), etc.) may be efficiently and/or effectively removed.

In a drying step (S3), a semiconductor device may be inserted into a dryer and then ejected with an inert gas, thereby performing cleaning and drying, in accordance with embodiments. In embodiments, a semiconductor device is cleaned by ejecting an inert gas thereto, without using deionized water (DIW), so that generation of corrosion can be prevented on the semiconductor device after cleaning the semiconductor device. In embodiments, cleaning effectiveness (e.g. which by itself may not be as effective as using deionized water) may be supplemented by extending the ejected time of the inert gas. For example, the ejected time of the inert gas may be twice as long as a method that uses deionized water.

In embodiments, a dryer (e.g. a malangoni dryer) may remove residues from a semiconductor device utilizing malangony effects and allow the inert gas to be ejected (e.g. for approximately 550 to approximately 650 seconds) using relatively high temperature nitrogen (N2), thereby performing the cleaning and drying of the semiconductor device.

In the related art, a method of fabricating a semiconductor device may insert a semiconductor device into a dryer filled with deionized water to eject iso propyl alcohol and discharge it slowly, in a drying step. However, in embodiments, a method of fabricating a semiconductor device may insert a semiconductor device into an empty dryer and then eject nitrogen, thereby accomplishing a drying step. Since the semiconductor device is in state where it is processed by iso propyl alcohol by being subject to the iso propyl alcohol cleaning step (S2), a cleaning process using iso propyl alcohol in the drying step may not be necessary, in accordance with embodiments.

In post ash step (S4), cleaning effects may be supplemented by additionally performing a post ash process on the semiconductor device being subject to the drying step (S3), in accordance with embodiments. In embodiments, since the semiconductor device is not subject to a cleaning process using deionized water in the drying step (S3), some iso propyl alcohol may remain on the semiconductor device. Accordingly, a post ash process may be performed to supplement cleaning effects, in accordance with embodiments.

Example FIG. 3 is a view illustrating the state of a semiconductor device after a cleaning process, in accordance with embodiments. As illustrated in FIGS. 2 and 3, a semiconductor device being subject to a cleaning process in accordance with embodiments may result in effective and/or efficient cleaning where corrosion substantially does not occur and residues do not substantially remain on the semiconductor device, in accordance with embodiments.

A method of cleaning a semiconductor device according to embodiments implements cleaning without using deionized water, so that corrosion may be prevented. In other words, by avoiding the use of deionized water during cleaning, while being able to substantially remove containments from the semiconductor device, corrosion can be avoided in a efficient and effective cleaning process, in accordance with embodiments.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method comprising:
chemical cleaning a semiconductor device using an organic solvent without using deionized water;
iso propyl alcohol cleaning the semiconductor device using iso propyl alcohol; and
drying the semiconductor device in a dryer and then ejecting an inert gas on the semiconductor device to simultaneously dry and clean the semiconductor device.

2. The method of claim 1, wherein the dryer is a malangoni dryer.

3. The method of claim 2, wherein a relatively high temperature nitrogen inert gas is injected into the dryer.

4. The method of claim 3, wherein the nitrogen is injected for approximately 550 seconds to approximately 650 seconds.

5. The method of claim 1, wherein the iso propyl alcohol cleaning comprises:
an injected cleaning that substantially cleans chemical residues from the organic solvent absorbed in the semiconductor device due to a temperature change by injecting normal temperature iso propyl alcohol onto the semiconductor device; and
dipped cleaning by dipping and cleaning the semiconductor device being subject to the injected cleaning at a normal temperature of iso propyl alcohol.

6. The method of claim 1, wherein the organic solvent is ACT-CMI.

7. The method of claim 1, comprising performing a post ash on the semiconductor device being subject to the drying.

8. The method of claim 5, wherein the iso propyl alcohol is injected at a normal temperature.

9. The method of claim 1, wherein the chemical cleaning cleans the semiconductor device where a pad open process is performed.

10. The method of claim 1, wherein the chemical cleaning cleans the semiconductor device where a backgrind process is performed.

11. An apparatus comprising a semiconductor device, wherein the semiconductor device is cleaned by:
chemical cleaning the semiconductor device using an organic solvent without using deionized water;
iso propyl alcohol cleaning the semiconductor device using iso propyl alcohol; and
drying the semiconductor device in a dryer and then ejecting an inert gas on the semiconductor device to simultaneously dry and clean the semiconductor device.

12. The apparatus of claim 11, wherein the dryer is a malangoni dryer.

13. The apparatus of claim 12, wherein a relatively high temperature nitrogen inert gas is injected into the dryer.

14. The apparatus of claim 13, wherein the nitrogen is injected for approximately 550 seconds to approximately 650 seconds.

15. The apparatus of claim 11, wherein the iso propyl alcohol cleaning comprises:
an injected cleaning that substantially cleans chemical residues from the organic solvent absorbed in the semiconductor device due to a temperature change by injecting normal temperature iso propyl alcohol onto the semiconductor device; and
dipped cleaning by dipping and cleaning the semiconductor device being subject to the injected cleaning at a normal temperature of iso propyl alcohol.

16. The apparatus of claim 11, wherein the organic solvent is ACT-CMI.

17. The apparatus of claim 11, where the semiconductor device is cleaned by performing a post ash on the semiconductor device being subject to the drying.

18. The apparatus of claim 15, wherein the iso propyl alcohol is injected at a normal temperature.

19. The apparatus of claim 11, wherein the chemical cleaning cleans the semiconductor device where a pad open process is performed.

20. The apparatus of claim 11, wherein the chemical cleaning cleans the semiconductor device where a backgrind process is performed.
